(19) United States
(12) Patent Application Publication
(10) Pub. No.: US 2004/0028127 A1
(43) Pub. Date: Feb. 12, 2004

(54) Method and apparatus for reducing computational complexity in video encoders

(76) Inventor: Raghavan Subramaniyan, Schaumburg, IL (US)

Correspondence Address: MOTOROLA INC, 600 NORTH US HIGHWAY 45, LIBERTYVILLE, IL, 60048-5343, US

(21) Appl. No.: 10/213,704

(22) Filed: Aug. 6, 2002

(51) Int. Cl. H04N 7/12

(52) U.S. Cl. 375/240.01; 375/240

(57) ABSTRACT

A method and apparatus for reducing computational complexity in a video encoder system. The method can include receiving transformed video block data coefficients, setting a threshold, determining if at least one transformed video block data coefficient's magnitude is greater than the threshold, performing subsequent compression functions if the at least one transformed video block data coefficient's magnitude is greater than the threshold, and bypassing subsequent compression functions if none of the transformed video block data coefficients' magnitudes are greater than the threshold.

### BACKGROUND OF THE INVENTION

1. Field of the Invention

This invention relates to the field of video encoding. In particular, this invention relates to the encoding of a block of video data.

2. Description of Related Art

Presently, in international video compression standards such as H.263, MPEG-2, and MPEG-4, a frame is composed of macroblocks. A macroblock is composed of blocks, which are composed of 64 elements. Focusing upon the encoding of a specific block of data, FIG. 5 depicts an encoding process. After the quantization by a quantizer of discrete cosine transform (DCT) coefficients generated by a DCT module, it is possible that there is no non-zero output produced even if the input to the quantizer was non-zero. In such a case, there are no quantized coefficients to be encoded by a variable length code (VLC) encoder. There is a flag called Coded Block Pattern (CBP) for each block of data. If there are no coefficients to be encoded, this flag is set to zero for that particular block and no quantization is performed. Otherwise it is set to 1 and quantization is performed, the quantized DCT coefficients are scanned in a zig-zag fashion by a scanner and then encoded by the VLC encoder and transmitted in a compressed video bitstream along with motion vectors.

In low bit rate applications, there are a high percentage of blocks that end up having no non-zero coefficient to be encoded (i.e., CBP=0). Thus, unfortunately, this means the quantization operation is often redundant.

Another problem exists in that the quantization operation is quite expensive. In the most commonly used quantization algorithm a particular DCT coefficient is quantized as follows:

Let:

The DCT coefficient be denoted by COEF[i]; i=0, 1, . . . 63

The quantization step size be denoted by Q

The output of the Quantizer block be denoted by QCOEF[i]

For each value of index “i”, the quantization is carried out by the following set of operations:

SGN=Sign(COEF[i])

ABSVAL=Abs(COEF[i])

QCOEF[i]=SGN * (ABSVAL/(2 * Q))

The function Sign( ) returns a value of 0, 1 or −1 depending upon whether the input is equal to zero, greater than zero or less than zero. The function Abs( ) returns the absolute value (magnitude) of the input.

It is evident from the equation that there are several operations to be performed per coefficient in the quantization process. In the equations, it is possible to eliminate the expensive “divide” operation by a multiplication. Unfortunately, the number of operations is still quite high and at least 10% of the computing resources are consumed in an encoder.

### SUMMARY OF THE INVENTION

A method and apparatus for reducing computational complexity in a video encoder system. The method can include receiving transformed video block data coefficients, setting a threshold, determining if at least one transformed video block data coefficient is greater than the threshold, performing subsequent compression functions if the at least one transformed video block data coefficient is greater than the threshold, and bypassing subsequent compression functions if none of the transformed video block data coefficients are greater than the threshold.

### BRIEF DESCRIPTION OF THE DRAWINGS

FIG. 1 is an exemplary block diagram of a video compression system for use with the present invention according to a preferred embodiment;

FIG. 2 is an exemplary block diagram of a block encoding system for the video compression system according to a preferred embodiment;

FIG. 3 is an exemplary flowchart outlining the operation of the check quantize required module according to one embodiment;

FIG. 4 is an exemplary block diagram of a check quantize required module 210 according to one embodiment; and

FIG. 5 depicts an encoding process.

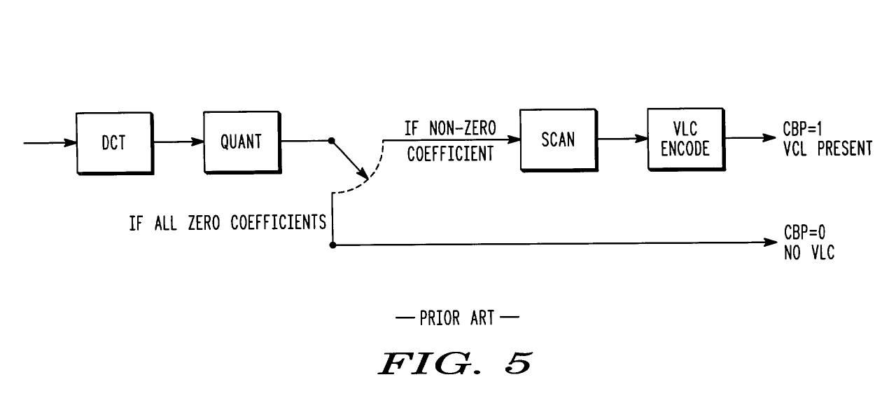

### DETAILED DESCRIPTION OF PREFERRED EMBODIMENTS

At low bit rates (e.g. QCIF at 64 kbps), as many as 75% of video compression blocks end up being not coded (i.e., with CBP=0). Thus, there is a large potential for saving computations if there is an easier way of determining beforehand whether quantization is necessary or not. Among other benefits, according to one embodiment, the disclosed invention can reduce the overall number of computations that are done by the encoder by eliminating all redundant block quantization operations. Among other benefits, according to a related embodiment, the reduced complexity of video encoder implementations can also contribute to reduction of system cost.

According to a related embodiment, redundant quantization operations in the encoder can be eliminated by introducing a new functional block before a quantization that performs a quick and efficient check whether a quantizer would produce a non-zero coefficient. The savings in computation can arise from the fact that the new functional block is significantly less complex than the quantizer function.

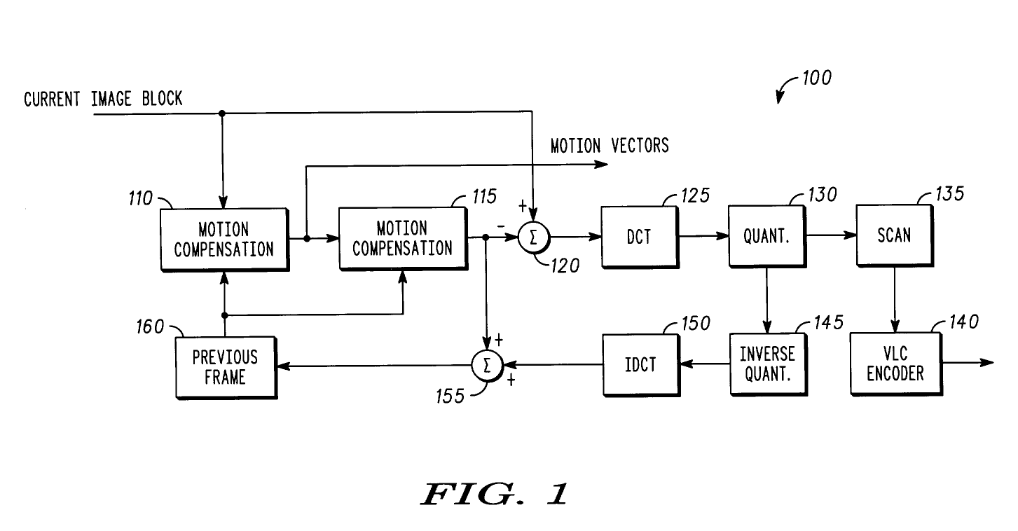

FIG. 1 is an exemplary block diagram of a video compression system 100 for use with the present invention according to one embodiment. The video compression system 100 can include a motion estimation module 110, a motion compensation module 115, an adder 120, a discrete cosine transform module (DCT) 125, a quantizer 130, a scan module or scanner 135, a variable length code (VLC) encoder 140, an inverse quantizer 145, an inverse discrete cosine transform circuit (IDCT) 150, another adder 155, and a previous frame circuit 160.

In operation, motion estimation is computed for blocks of image data from a current image frame using one or more previously processed image frames. The motion estimation circuit 110 outputs a motion vector corresponding to a processed block. The motion compensation circuit 115 forms a prediction block from the previous frame using the computed motion vectors. The adder 120 computes a difference image by subtracting the predicted image data from a current image frame. This difference image is transformed using the DCT 125. The DCT coefficients are subsequently subject to reduced precision by the quantizer 130. The quantizer 130 increases compression while introducing numerical loss. The scanner 135 scans the quantized DCT coefficients in a zig-zag fashion. The scanned DCT coefficients are then encoded by the VLC encoder 140 and transmitted in a compressed video bitstream along with the motion vectors. A local reconstruction loop is comprised of the inverse quantizer 145, the IDCT 150, and the adder 155. The inverse quantizer 145 reconstructs the DCT coefficients. The IDCT 150 transforms the DCT coefficients back into the spatial domain to form a quantized difference image. The resulting reconstructed frame is computed by the adder 155 by adding the motion compensated data to the quantized difference image. This reconstructed data is then stored for use in the previous frame module 160 for processing subsequent image frames.

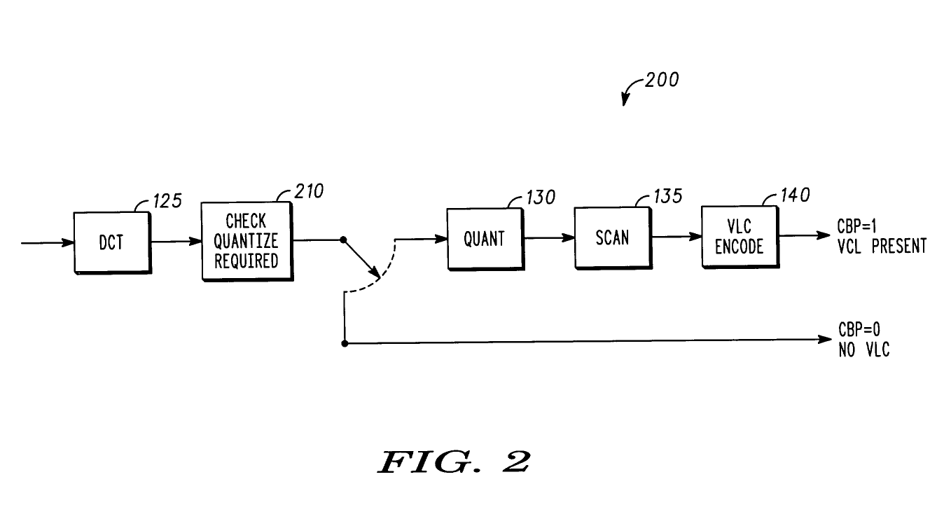

FIG. 2 is an exemplary block diagram of a block encoding system 200 for the video compression system 100 according to a preferred embodiment. The block encoding system 200 includes a check quantize required module 210 located before the quantizer 130, the scanner 135, and the VLC encoder 140. The block encoding system 200 can be incorporated into the quantizer 130, the scanner 135, and the VLC encoder 140 in the video compression system 100. In operation, the check quantize required module 210 performs a quick check to decide whether the DCT 125 output will produce a non-zero coefficient.

There are several possible embodiments possible for implementing the check quantize required module 210. The one that is more efficient can depend upon the actual platform on which the encoder is running. In all embodiments, the check quantize required module 210 determines whether a DCT coefficient exists whose magnitude is greater than a threshold THRESH.

The value of THRESH can be a function of a quantization step size and a quantization algorithm. In the preferred embodiment, there are at least two types of quantization algorithms: normal and deadzone quantization algorithms.

The normal quantization algorithm can perform the following steps of operations for each DCT coefficient:

SGN=Sign(COEF[i])

ABSVAL=Abs(COEF[i])

QCOEF[i]=SGN * (ABSVAL/(2 * Q))

Where:

The DCT coefficient be denoted is COEF[i]; i=0, 1, . . . 63

Q denotes the quantization step size

The output of the quantizer module 130 is denoted by QCOEF[i]

The function Sign( ) can return a value of 0, 1 or −1 depending upon whether the input is equal to zero, greater than zero or less than zero.

The deadzone quantization algorithm can be performed by the following set of operations:

SGN=Sign(COEF[i])

ABSVAL=Abs(Abs(COEF[i])−Q/4)

QCOEF[i]=SGN * (ABSVAL/(2 * Q))

For normal quantization, THRESH=(2*Q−1), where Q is the quantization step size. For deadzone quantization, THRESH=(2*Q+Q/4−1)

There are many possible embodiments for a function to check if at least one coefficient equals or exceeds the value of THRESH. For example:

Embodiment 1:

MAXCOEF = 0
For i = 0 to 63

If (Abs(COEF[i]) > MAXCOEF)

MAXCOEF = COEF[i]

Endif

End
If (MAXCOEF > THRESH)

CBP = 1

Else

CBP = 0

Endif

Embodiment 2:

CBP = 0
For i = 0 to 63

If (Abs(COEF[i]) > THRESH)

CBP = 1
Break out of the FOR loop

Endif

End

There could be other variants of the embodiment, but the principle is the same: to determine whether there exists at least one coefficient whose magnitude is greater than a threshold.

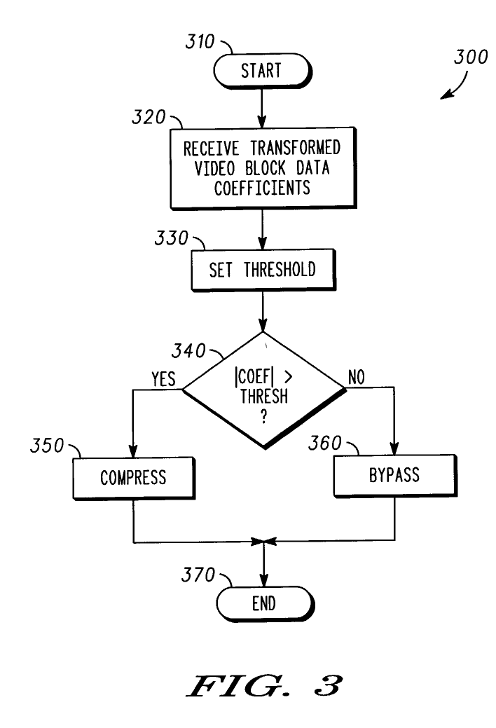

FIG. 3 is an exemplary flowchart 300 outlining the operation of the check quantize required module 210 according to one embodiment. In step 310, the flowchart begins. In step 320, the check quantize required module 210 receives transformed video block data coefficients. In step 330, the check quantize required module 210 determines a threshold. For example, the check quantize required module 210 can determine a threshold by retrieving a stored threshold, calculating a threshold, receiving a threshold input, or determine a threshold by any other useful means. In step 340, the check quantize required module 210 determines if the magnitude of at least one transformed video block data coefficient is greater than the threshold. If true, the check quantize required module 210 advances to step 350. If false, check quantize required module 210 advances to step 360. In step 350, the check quantize required module 210 sends the transformed video block data to further compression circuitry. In step 360, the check quantize required module 210 bypasses further compression circuitry such as the quantizer 130. In step 370, the flowchart ends.

Thus, according to one embodiment, the present invention provides a method for reducing computational complexity in a video encoder system such as the video compression system 100. The method can include receiving transformed video block data coefficients, setting a threshold, determining if at least one transformed video block data coefficient's magnitude is greater than the threshold, performing subsequent compression functions if the at least one transformed video block data coefficient's magnitude is greater than the threshold, and bypassing subsequent compression functions if none of the transformed video block data coefficients' magnitudes are greater than the threshold. The method can also include performing a discrete cosine transform on video block data to generate video block data coefficients.

The step of determining if at least one transformed video block data coefficient's magnitude is greater than the threshold can include iteratively comparing a coefficient's magnitude to a maximum value of previous coefficients' magnitudes, setting the coefficient's magnitude as the maximum value if the coefficient's magnitude is greater than the maximum value of the previous coefficients' magnitudes, and determining if the maximum value is greater than a threshold. The step of determining if at least one transformed video block data coefficient's magnitude is greater than the threshold further can include beginning to perform an iterative comparison of each of the transformed video block data coefficients' magnitudes to a threshold value, and ending the iterative comparison when the absolute value of one transformed video block data coefficient's magnitude exceeds the threshold. The step of performing subsequent compression functions if the at least one transformed video block data coefficient's magnitude is greater than the threshold further can include quantizing the transformed video block data coefficients. The step of performing subsequent compression functions if the at least one transformed video block data coefficient's magnitude is greater than the threshold further can include scanning the transformed video block data coefficients.

The step of performing subsequent compression functions if the at least one transformed video block data coefficient's magnitude is greater than the threshold can include quantizing the transformed video block data coefficients to generate quantized transformed video block data coefficients, scanning the quantized transformed video block data coefficients to generate scanned quantized transformed video block data coefficients, and variable length code encoding the scanned quantized transformed video block data coefficients. The step of setting the threshold can set the threshold to approximately twice a quantization step size minus one based on a use of a normal quantization algorithm, to approximately twice a quantization step size plus approximately one quarter the quantization step size minus 1 based on a use of a deadzone quantization algorithm, or to any other useful threshold.

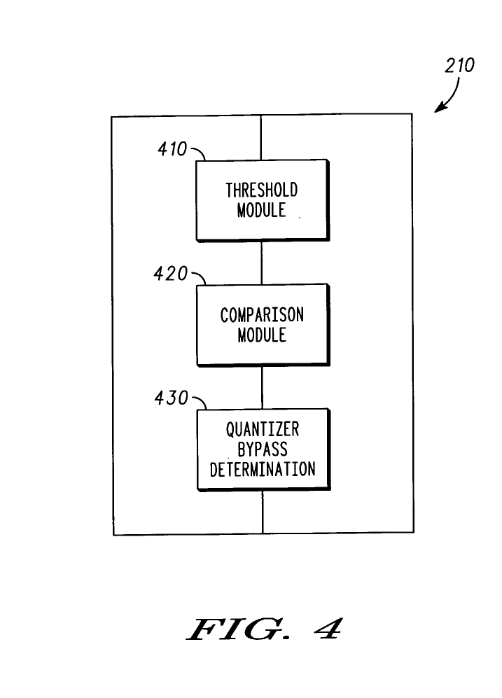

FIG. 4 is an exemplary block diagram of a check quantize required module 210 according to one embodiment. The check quantize required module 210 can include a threshold module 410, a transformed video block data to threshold comparison module 420, and a quantizer bypass determination module 430. The threshold module 410 can store a threshold, can calculate a threshold, can receive a threshold input, or can obtain a threshold in any other useful manner.

The transformed video block data to threshold comparison module 420 can be configured to iteratively compare a coefficient's magnitude to a maximum value of previous coefficients' magnitude, set the coefficient's magnitude as the maximum value if the coefficient's magnitude is greater than the maximum value of the previous coefficients' magnitude, and determine if the maximum coefficient's magnitude is greater than a threshold. The transformed video block data to threshold comparison module 420 can also be configured to begin to perform an iterative comparison of each of the transformed video block data coefficients' magnitudes to a threshold value, and end the iterative comparison when the absolute value of one transformed video block data coefficient exceeds the threshold.

According to one embodiment, the savings in computations are quite significant. For example, the number of operations in the check quantize required module 210 can be several times lower than the quantizer 130. For example, consider the case with the following parameters:

75% of blocks are not coded (CBP=0).

The check quantize required module does N operations per block.

The quantizer takes 4N operations per block (4 times).

There are 10000 blocks that need to be processed per second.

Without the check quantize required module 210, the number of operations needed per second is 40000*N. With the check quantize required module 210, the operations needed are

10000*N+0.25*4*N*10000=20000*N

Thus there is a saving of 50% in this example.

According to another embodiment, the present application can be incorporated into a real time video encoder in a mobile communication device, a hand held device, or the like. Thus, this embodiment can provide a mobile communication device including an apparatus for reducing computational complexity in a video encoder system 100. The apparatus can include a video data block coefficient transformer 125 configured to generate transformed video data block coefficients, a check quantize required module 210 coupled to the video data block coefficient transformer 125, the check quantize required module including a quantize bypass circuit, and a quantizer 130 coupled to the check quantize required module 210. The check quantize required module 210 can include a threshold module 510, a transformed video block data to threshold comparison module 520, and a quantizer bypass determination module 530. The check quantize required module 210 can be configured to determine if at least one transformed video data block coefficient is at least one of equal and greater to a threshold.

The method of this invention is preferably implemented on a programmed processor. However, the video compression system 100, the check quantize required module 210, and other elements may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures and the methods described may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

What is claimed is:

1. A method for reducing computational complexity in a video encoder system, comprising:
receiving transformed video block data coefficients;
setting a threshold;
determining if at least one transformed video block data coefficient's magnitude is greater than the threshold;
performing subsequent compression functions if the at least one transformed video block data coefficient's magnitude is greater than the threshold; and
bypassing subsequent compression functions if none of the transformed video block data coefficients' magnitudes are greater than the threshold.

2. The method according to claim 1, further comprising performing a discrete cosine transform on video block data to generate video block data coefficients.

3. The method according to claim 1, wherein the step of determining if at least one transformed video block data coefficient's magnitude is greater than the threshold further comprises:
iteratively comparing a coefficient's magnitude to a maximum value of previous coefficients' magnitudes;
setting the coefficient's magnitude as the maximum value if the coefficient's magnitude is greater than the maximum value of the previous coefficients' magnitudes; and
determining if the maximum coefficient's magnitude is greater than a threshold.

4. The method according to claim 1, wherein the step of determining if at least one transformed video block data coefficient's magnitude is greater than the threshold further comprises:
beginning to perform an iterative comparison of each of the transformed video block data coefficients' magnitudes to a threshold value; and
ending the iterative comparison when the absolute value of one transformed video block data coefficient exceeds the threshold.

5. The method according to claim 1, wherein the step of performing subsequent compression functions if the at least one transformed video block data coefficient's magnitude is greater than the threshold further comprises quantizing the transformed video block data coefficients.

6. The method according to claim 1, wherein the step of performing subsequent compression functions if the at least one transformed video block data coefficient's magnitude is greater than the threshold further comprises scanning the transformed video block data coefficients.

7. The method according to claim 1, wherein the step of performing subsequent compression functions if the at least one transformed video block data coefficient's magnitude is greater than the threshold further comprises:
quantizing the transformed video block data coefficients to generate quantized transformed video block data coefficients;
scanning the quantized transformed video block data coefficients to generate scanned quantized transformed video block data coefficients; and
variable length code encoding the scanned quantized transformed video block data coefficients.

8. The method according to claim 1, wherein the step of setting the threshold sets the threshold to approximately twice a quantization step size minus 1.

9. The method according to claim 8, wherein the step of setting the threshold sets the threshold to approximately twice a quantization step size minus 1 based on a use of a normal quantization algorithm.

10. The method according to claim 1, wherein the step of setting the threshold sets the threshold to approximately twice a quantization step size plus approximately one quarter the quantization step size minus 1.

11. The method according to claim 10, wherein the step of setting the threshold sets the threshold to approximately twice a quantization step size plus approximately one quarter the quantization step size minus 1 based on a use of a deadzone quantization algorithm.

12. The method according to claim 1, wherein the step of performing subsequent compression functions if the at least one transformed video block data coefficient's magnitude is greater than the threshold further comprises:
scanning the transformed video block data coefficients to generate scanned quantized transformed video block data coefficients; and
quantizing the scanned transformed video block data coefficients to generate quantized transformed video block data coefficients;
variable length code encoding the quantized scanned transformed video block data coefficients.

13. A video encoder apparatus, comprising:
a video data block coefficient transformer;
a check quantize required module coupled to the video data block coefficient transformer; and
a quantizer coupled to the check quantize required module.

14. The apparatus according to claim 13, wherein the check quantize required module includes a quantizer bypass module.

15. The apparatus according to claim 13, wherein the check quantize required module comprises
a threshold module;
a transformed video block data to threshold comparison module; and
a quantizer bypass determination module.

16. The apparatus according to claim 15, wherein the transformed video block data to threshold comparison module is configured to
iteratively compare a coefficient's magnitude to a maximum value of previous coefficients' magnitudes,
set the coefficient's magnitude as the maximum value if the coefficient's magnitude is greater than the maximum value of the previous coefficients' magnitude, and
determine if the maximum coefficient's magnitude is greater than a threshold.

17. The apparatus according to claim 15, wherein the transformed video block data to threshold comparison module is configured to
begin to perform an iterative comparison of each of the transformed video block data coefficients' magnitudes to a threshold value; and
end the iterative comparison when the absolute value of one transformed video block data coefficient exceeds the threshold.

18. The apparatus according to claim 13, wherein the video data block coefficient transformer comprises a discrete cosine transform module.

19. The apparatus according to claim 13, further comprising a scanner coupled between the check quantize required module and the quantizer.

20. The apparatus according to claim 13, further comprising:
a scanner coupled to the quantizer; and
a variable length code encoder coupled to the scanner.

21. The apparatus according to claim 13, further comprising:
a motion estimation module including a current image block input;
a motion compensation module coupled between the motion estimation module and the video data block coefficient transformer.

22. The apparatus according to claim 21, further comprising a local reconstruction loop coupled between the quantizer and the motion estimation module.

23. A mobile communication device including an apparatus for reducing computational complexity in a video encoder system, comprising:
a video data block coefficient transformer configured to generate transformed video data block coefficients;
a check quantize required module coupled to the video data block coefficient transformer, the check quantize required module including a quantize bypass circuit; and
a quantizer coupled to the check quantize required module.

24. The apparatus according to claim 23, wherein the check quantize required module comprises:
a threshold module;
a transformed video block data to threshold comparison module; and
a quantizer bypass determination module.

25. The apparatus according to claim 23, wherein the check quantize required module is configured to determine if at least one transformed video data block coefficient's magnitude is at least one of equal and greater to a threshold.
